(19) United States
(12) Patent Application Publication
(10) Pub. No.: US 2024/0357710 A1
(43) Pub. Date: Oct. 24, 2024

(54) INFRARED HEATING WIRE AND HEATING DEVICE

(71) Applicant: EAGLE ELECTRIC (SHENZHEN) CO., LTD., Shenzhen (CN)

(72) Inventor: Longhuang ZHANG, Shenzhen (CN)

(21) Appl. No.: 18/644,160

(22) Filed: Apr. 24, 2024

(30) Foreign Application Priority Data
Apr. 24, 2023 (CN) 202320985503.3

(51) Int. Cl. H05B 3/10; H05B 1/02

(52) U.S. Cl. CPC H05B 3/10; H05B 1/0272

(57) ABSTRACT

Disclosed are an infrared heating wire and a heating device. The infrared heating wire comprises an infrared heating body, a PTC heating layer, an NTC temperature measuring layer and an outer cover. The infrared heating body is used to heat and emit infrared rays when being powered on. The PTC heating layer is used to heat when being powered on. The PTC heating layer and the NTC temperature measuring layer are electrically connected with a control circuit. The NTC temperature measuring layer is used to detect temperature information about the PTC heating layer and that of the infrared heating body and transfer the temperature information to the control circuit. The outer cover is used to wrap the infrared heating body, the PTC heating layer and the NTC temperature measuring layer.

### CROSS REFERENCE TO RELATED APPLICATIONS

The present application claims the benefit of Chinese Patent Application No. 202320985503.3 filed on Apr. 24, 2023, the contents of which are incorporated herein by reference in their entirety.

### TECHNICAL FIELD

The present disclosure relates to electric heating, in particular to infrared heating elements and heating devices.

### BACKGROUND OF THE INVENTION

PTC/NTC heating wires are often used for heating in existing heating devices such as heating blankets, heating products for a part of human body. With the characteristics of PTC/NTC heating wires, constant temperature heating and temperature control for overheating protection can both be achieved. As diversified demands of users for heating devices increase, improvement of functionality of heating products is a current direction for heating devices. However, the existing heating devices only have a simple function, i.e. heating, which is unable to meet user needs.

### SUMMARY OF THE INVENTION

An infrared heating element and a heating device provided in the present disclosure can solve problems existed in the existing heating device, i.e. only having a single function and being unable to meet user needs.

According to a first aspect, an infrared heating element provided in the present disclosure may include an infrared heating body, a PTC heating layer, an NTC temperature measuring layer and an outer cover. The infrared heating body may be used to heat and emit infrared rays when being powered on. The PTC heating layer may be used to heat when being powered on, to electrically connect with a control circuit, and to transfer temperature information about the PTC heating layer to the control circuit. The NTC temperature measuring layer may be used to electrically connect with the control circuit, to detect temperature information about the PTC heating layer and the infrared heating body and transfer the temperature information to the control circuit. The outer cover may be used to wrap the infrared heating body, the PTC heating layer and the NTC temperature measuring layer.

In some embodiments, the infrared heating body may comprise a carbon fiber heater.

In some embodiments, the NTC temperature measuring layer may wrap an outer surface of the infrared heating body, and the PTC heating layer may be arranged on an outer surface of the NTC temperature measuring layer.

In some embodiments, the carbon fiber heater may comprise a plurality of carbon fiber heating wires interlaced with each other.

In some embodiments, the PTC heating layer may comprise a PTC heating wire spirally surrounding the outer surface of the NTC temperature measuring layer.

In some embodiments, Curie temperatures of the PTC heating layer and the NTC temperature measuring layer may be a, which is ranged between 30° C. and 105° C.

In some embodiments, the material of the outer cover may be one selected from polyvinyl chloride, polyethylene, fluoroplastic, polyamide plastic, polyurethane plastic, polypropylene, polystyrene, chlorinated polyethylene and ethylene-vinyl acetate copolymer.

In some embodiments, the number of the carbon fiber heating wires is 1K-48K.

In some embodiments, the thickness of the outer cover is 0.1 mm-1 mm.

According to a second aspect, a heating device provided in the present disclosure may include a control circuit and the infrared heating element mentioned above; the control circuit may be electrically connected with the infrared heating element, so that the control circuit can control a heating temperature of the infrared heating element.

According to the present disclosure, the infrared heating element and the heating device are provided. The infrared heating element may include an infrared heating body, a PTC heating layer, an NTC temperature measuring layer and an outer cover. The infrared heating body may be configured to heat and emit infrared rays when being powered on. The PTC heating layer may be configured to heat when being powered on, and to electrically connect with a control circuit and transfer the temperature information about the PTC heating layer to the control circuit. The NTC temperature measuring layer may be configured to electrically connect with the control circuit, and to detect the temperature information about the PTC heating layer and the infrared heating body and transfer the temperature information to the control circuit. The outer cover may wrap the infrared heating body, the PTC heating layer and the NTC temperature measuring layer. The infrared heating element in some embodiments of the present disclosure can not only heat by means of the PTC heating layer and the infrared heating body, but also control temperature by means of the PTC heating layer and the NTC temperature measuring layer. Further, the control circuit can control the temperature of the PTC heating layer according to the temperature change of the PTC heating layer, and can control the temperature of the PTC heating layer and that of the infrared heating body according to the temperature detected by the NTC temperature measuring layer. The infrared heating body can also emit infrared rays needed by the human body while heating, which can meet the needs of heating products for human body for both heating and emitting infrared rays. The infrared heating element and the heating device in some embodiments of the present disclosure can solve the problem existed in existing heating devices, i.e. only having a single function, and improve diversities of functions of the heating devices.

### BRIEF DESCRIPTION OF THE DRAWINGS

FIG. 1 is a schematically structural diagram of an infrared heating element provided by some embodiments of the present disclosure; and

FIG. 2 is a schematically sectional diagram of an infrared heating element provided by some embodiments of the present disclosure.

### DETAILED DESCRIPTION

The present disclosure is further described in detail below through specific embodiments in combination with the drawings, wherein, similar elements in different embodiments adopt associated similar element labels. In the following embodiments, many details are described in order to make the application be better understood. However, those skilled in the art can easily realize that some features can be omitted in different cases or can be replaced by other elements, materials and methods. In some cases, some operations related to the present disclosure are not shown or described in the specification in order to avoid the core part of the present disclosure being overwhelmed by excessive descriptions, and for those skilled in the art, it is not necessary to describe these relevant operations in detail, they can completely understand the relevant operations according to the description in the specification and the general technical knowledge of the field.

In addition, the features, operations or characteristics described in the specification may be combined in any appropriate manner to form various embodiments. At the same time, the steps or actions described in the method may be sequenced or adjusted in a manner apparent to those skilled in the art. Therefore, the sequences in the specification and the drawings are intended to clearly describe an embodiment and are not meant to be a required sequence unless it is indicated otherwise that a sequence must be followed.

The serial numbers assigned to the parts in the present disclosure, such as “first”, “second”, etc., are only used to distinguish the described objects, and do not have any sequential or technical meaning. The terms “connect” and “couple” as mentioned in the present disclosure, unless otherwise specified, include direct and indirect connection (coupling).

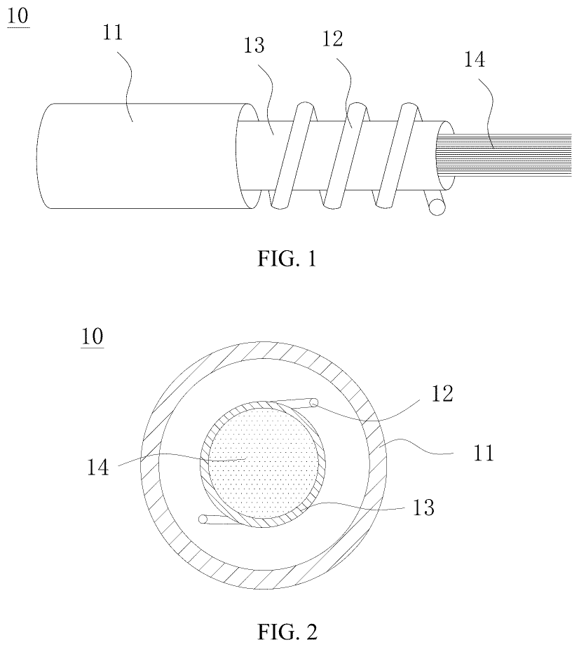

Please refer to FIG. 1 and FIG. 2. FIG. 1 is a schematically structural diagram of an infrared heating element 10 provided in some embodiments of the present disclosure; and FIG. 2 is a schematically sectional diagram of an infrared heating element 10 provided in some embodiments of the present disclosure. The infrared heating element 10 in some embodiments of the present disclosure may be adopted in heating devices, such as heating blankets, electric blankets, pet blankets, heating boots, heating products for a part of human body, and other heat preservation and heating products. The infrared heating element 10 may comprise an outer cover 11, a PTC heating layer 12, an NTC temperature measuring layer 13 and an infrared heating body 14.

The outer cover 11 may wrap the infrared heating body 14, the PTC heating layer 12 and the NTC temperature measuring layer 13 to protect them.

Specifically, the PTC heating layer 12 may be used for heating when being powered on. PTC is the abbreviation of positive temperature coefficient; and PTC mentioned herein may refer to a positive temperature coefficient thermistor. When the temperature of a PTC thermistor exceeds the Curie temperature, its resistance may increase step by step with the increase of temperature. The PTC heating layer 12 may also be used to electrically connect with a control circuit and transmit temperature information about the PTC heating layer 12 to the control circuit. Specifically, the control circuit may include a CPU and a first voltage comparator. When the temperature of the PTC heating layer 12 increases, the resistance of the PTC heating layer 12 may increase and the sampling voltage of the PTC heating layer 12 may decrease. When the sampling voltage is lower than a set reference voltage, the first voltage comparator may output a low potential. When the CPU detects a low potential, it may stop outputting a trigger pulse and may turn off a thyristor to cut off output; and then the resistance of the PTC heating layer 12 may slowly decrease, the sampling voltage of the PTC heating layer 12 may increase. When the sampling voltage increases to such a potential that the first voltage comparator can be flipped to a high potential and a high potential may be detected, the CPU may output a trigger pulse and may turn on the thyristor to resume output. The control circuit may cut off the output as the resistance of the PTC heating layer 12 increases, and may perform heating as the resistance decreases, so as to achieve cyclic control for constant temperature control.

The NTC temperature measuring layer 13 may be configured to be electrically connected with the control circuit, and the NTC temperature measuring layer 13 may be configured to detect temperature information about the PTC heating layer 13 and the infrared heating body 14, and transmit the temperature information to the control circuit. NTC is the abbreviation of negative temperature coefficient; and NTC mentioned herein may refer to a negative temperature coefficient thermistor. When the temperature of an NTC thermistor exceeds the Curie temperature, its resistance may decrease significantly with the increase of temperature.

The infrared heating element 10 in the present disclosure may also use the NTC characteristics of a middle layer of the heating wire to achieve temperature control. Specifically, the control circuit may include a CPU and a second voltage comparator. When the temperature of the PTC heating layer 12 and/or the infrared heating body 14 is high, the resistance of the NTC temperature measuring layer 13 may decrease, and the sampling voltage of the NTC temperature measuring layer 13 may increase. When the sampling voltage is higher than a set reference potential, the second voltage comparator may output a low potential, the CPU may detect a low potential and then cut off output. Then the resistance of the NTC temperature measuring layer 13 may slowly increase; and when the resistance of the NTC temperature measuring layer 13 increases, the sampling voltage of NTC temperature measuring layer 13 may decrease. When the sampling voltage is low enough to make the second voltage comparator flip to a high potential, the CPU may detect a high potential and resume output. The entire control circuit may cut off the output at a high temperature and may heat up at a low temperature when the resistance increases to protect constant temperature and temperature control.

For the infrared heating element of the present disclosure, by means of connecting the PTC heating layer 12 and the NTC temperature measuring layer 13 with two voltage comparators respectively, the PTC heating layer 12 and the NTC temperature measuring layer 13 can both achieve temperature control protection; in this regard, the dual temperature control protect is more conducive to preventing the infrared heating element 10 from overheating.

The infrared heating body 14 may be configured to heat and emit infrared rays when being powered on. The infrared rays can promote the temperature of deep subcutaneous tissue of a human body, which can stimulate cell viability, cause the expansion of capillaries, accelerate of blood flow, double the microcirculatory blood flow, strengthen the metabolism between the various tissues of the human body, increase the regeneration ability of the tissue, improve the immunity of the human body, regulate the abnormal state of excitement, achieving preventing diseases and strengthening the body. Therefore, the infrared heating element of the present disclosure can emit the infrared when it is powered on, so that it not only has the function of heating, but also has obvious functions including medical treatment, health care and cold prevention; in this regard, such strong functionality can solve the problem in existing heating devices, i.e. only having a single function, and improves diversities of functions of the heating devices.

In some embodiment, the infrared heating body 14 may include a carbon fiber heater. Carbon fiber is a kind of fibrous carbon material, which has the characteristics of corrosion resistance, oxidation resistance, high stability, long service life, etc. It can generally reach a stable working time of 100000 hours at 300° C., with good heat conversion rate, fast heating, and stable resistance value. When the carbon fiber is heated, it can generate far-infrared rays with a wavelength of 2 μm-30 μm, resulting in resonance phenomenon. A human body is an organism composed of more than 70-80% water molecules. Under the effect of resonance, it may first activate the water molecules to vibrate to produce a series of physiological reactions, which can rise the temperature of cells in human skin and subcutaneous tissue to make the human body generate heat transfer from inside to outside, promote the blood circulation of the human body to help eliminate human fatigue and recover body function, enhance metabolism and improve the immune function of the human body.

In some embodiments, as shown in FIG. 1 and FIG. 2, the NTC temperature measuring layer 13 may wrap the outer surface of the infrared heating body 14, and the PTC heating layer 12 may be arranged on the outer surface of the NTC temperature measuring layer 13. With such a structure, the NTC temperature measuring layer 13 can sense both the temperature of the PTC heating layer 12 and that of the infrared heating body 14. No matter the temperature of either the PTC heating layer 12 or the infrared heating body 14 is too high, it can be detected by the NTC temperature measuring layer 13. In addition, the PTC heating layer 12 and the NTC temperature measuring layer 13 may wrap the outside of the infrared heating body 14 to double protect the infrared heating body 14, resulting in preventing the infrared heating body 14 from being damaged and losing its functions of heating and emitting infrared, and improving the product life of the infrared heating body 14.

In some embodiments, the carbon fiber heater may comprise a plurality of carbon fiber heating wires interlaced with each other. The number of the carbon fiber heating wires may be 1K-48K and can change the resistance value of the carbon fiber heater. The more the number of the carbon fiber heating wires, the smaller the resistance value of the carbon fiber heater.

In some embodiments, as shown in FIG. 1, the PTC heating layer 12 may include a PTC heating wire spirally surrounding the outer surface of the NTC temperature measuring layer 13. The spiral spacing of the PTC heating wire may be adjusted according to the needs of corresponding products.

In some embodiments, the Curie temperature of the PTC heating layer 12 and the NTC temperature measuring layer 13 are a, which may be ranged between 30° C. and 105° C.

In some embodiments, the outer cover 11 may be made of insulating materials, for example, the material of the outer cover 11 may be one of polyvinyl chloride, polyethylene, fluoroplastic, polyamide plastic, polyurethane plastic, polypropylene, polystyrene, chlorinated polyethylene and ethylene vinyl acetate copolymer. The thickness of the outer cover 11 may be 0.1 mm-1 mm.

A heating device is also provided in some embodiments of the present disclosure. The heating device may be a heating blanket, an electric blanket, a pet blanket, heating boots, heating products for a part of human body, and other heat preservation and heating products. The heating device may include a control circuit and an infrared heating element 10. The control circuit may be electrically connected to the infrared heating element 10, so that the control circuit can control the heating temperature of the infrared heating element. The infrared heating element 10 here may have the same or similar structure and achieve the same or similar effect as the infrared heating element to which any of the above embodiments relates.

For the heating device provided in some embodiments of the present disclosure, the infrared heating element 10 of the heating device may include an infrared heating body 14, a PTC heating layer 12, an NTC temperature measuring layer 13 and an outer cover 11. The infrared heating body 14 may be configured to heat and emit infrared rays when being powered on. The PTC heating layer 12 may be configured to heat when being powered on, and to electrically connect with a control circuit and transfer the temperature of the PTC heating layer to the control circuit. The NTC temperature measuring layer 13 may be configured to electrically connect with the control circuit, and to detect the temperature information about the PTC heating layer 12 and the infrared heating body 14 and transfer the temperature information to the control circuit. The outer cover 11 may wrap the infrared heating body 14, the PTC heating layer 12 and the NTC temperature measuring layer 13. The infrared heating element 10 in some embodiments of the present disclosure can not only heat by means of the PTC heating layer 12 and the infrared heating body 14, but also control temperature by means of the PTC heating layer 12 and the NTC temperature measuring layer 13. Further, the control circuit can control the temperature of the PTC heating layer 12 according to the temperature change of the PTC heating layer, and can control the temperatures of the PTC heating layer 12 and the infrared heating body 14 according to the temperature detected by the NTC temperature measuring layer 13. The infrared heating body 14 can also emit infrared rays needed by the human body while heating, which can meet the needs of heating products for human body for both heating and emitting infrared rays. The heating device in some embodiments of the present disclosure can solve the problem existed in the heating device in the prior art, i.e. having only a single function, and improve diversities of functions of the heating devices.

The present disclosure is described and illustrated by means of the above specific examples to only help understand the technical solution of the present disclosure, and not to limit thereto. For those skilled in the art, a number of simple deduction, deformation or replacement can also be made according to the idea of the present disclosure.

1. An infrared heating element, comprising:
an infrared heating body configured to heat and emit infrared rays when being powered on;
a PTC heating layer configured to heat when being powered on, to electrically connect with a control circuit, and to transfer temperature information about the PTC heating layer to the control circuit;
an NTC temperature measuring layer configured to electrically connect with the control circuit, to detect temperature information about the PTC heating layer and the infrared heating body, and to transfer the temperature information about the PTC heating layer and the infrared heating body to the control circuit; and
an outer cover configured to wrap the infrared heating body, the PTC heating layer and the NTC temperature measuring layer.

2. The infrared heating element according to claim 1, wherein the infrared heating body comprises a carbon fiber heater.

3. The infrared heating element according to claim 1, wherein the NTC temperature measuring layer wraps an outer surface of the infrared heating body, and the PTC heating layer is arranged on an outer surface of the NTC temperature measuring layer.

4. The infrared heating element according to claim 2, wherein the carbon fiber heater comprises a plurality of carbon fiber heating wires interlaced with each other.

5. The infrared heating element according to claim 3, wherein the PTC heating layer comprises a PTC heating wire spirally surrounding the outer surface of the NTC temperature measuring layer.

6. The infrared heating element according to claim 1, wherein Curie temperatures of the PTC heating layer and the NTC temperature measuring layer are a, which is ranged between 30° C. and 105° C.

7. The infrared heating element according to claim 1, wherein a material of the outer cover is one selected from polyvinyl chloride, polyethylene, fluoroplastic, polyamide plastic, polyurethane plastic, polypropylene, polystyrene, chlorinated polyethylene and ethylene-vinyl acetate copolymer.

8. The infrared heating element according to claim 4, wherein a number of the carbon fiber heating wires is 1K-48K.

9. The infrared heating element according to claim 1, wherein a thickness of the outer cover is 0.1 mm-1 mm.

10. A heating device, comprising a control circuit and the infrared heating element according to claim 1, the control circuit being electrically connected with the infrared heating element so that the control circuit controls a heating temperature of the infrared heating element.
